(19) United States
(12) Patent Application Publication
(10) Pub. No.: US 2003/0081760 A1
(43) Pub. Date: May 1, 2003

(54) Adapter socket seat of digital subscriber line

(76) Inventor: Michael Chen, Keelung (TW)

Correspondence Address: BIRCH STEWART KOLASCH & BIRCH, PO BOX 747, FALLS CHURCH, VA, 22040-0747, US

(21) Appl. No.: 09/984,445

(22) Filed: Oct. 30, 2001

(51) Int. Cl. H04M 1/00; H04M 9/00

(52) U.S. Cl. 379/399.01

(57) ABSTRACT

An adapter socket seat, which is used for connecting with a client line carrying voice signals distributed from a server, and especially with a line for carrying Digital Subscriber Line (DSL) signals, is disclosed in the invention. The signal splitter of the invention comprises a signal filter for preventing the Digital Subscriber Line (DSL) signals from being disturbed by the noises of the telephone. The adapter socket further comprises a plug for a direct link with a standard socket of a client line designed for carrying voice signals. Therefore, the invention does not require extra connection wires and it prevents the inconvenience caused by the need to put wires together. The invention is thus suitable for quick installment and removal.

### BACKGROUND OF THE INVENTION

1. Field of the Invention

The invention relates to an adapter socket seat, which is connected to a client line carrying voice signals distributed from a server, for filtering out noises caused by the operation of a telephone to maintain an equally high quality of operation for other devices using the same signal carrying line, such as a Modulation/Demodulation device (MODEM)

2. Related Art

The Digital Subscriber Line (DSL) is a dedicated digital line capable of transferring information to clients from families and small businesses via broadband network access, which is made possible by the connection between the computer systems and the digital lines using a modulation/demodulation (MODEM) device via common copper-based telephone lines.

Telephone systems are the most prevalent communication networks in the world today. In many countries, there is a telephone line connection for almost every family. Especially in some highly developed countries, some families subscribe to at least two telephone lines. Many users use telephone modems to access the Internet with a general transfer rate of 28.8 or 33.6 Kbps and up to 56 Kbps. If using a more updated standard, ITU or V.90 is adopted. While multimedia applications and real-time services have become more and more popular on the Internet, the huge data transfer rate of several megabytes a second for said multimedia applications is further aggravating the problem of insufficient bandwidth in the network. For resolving this problem, many new methods of data transfer are being proposed, and XDSL is a more notable application of technology among them.

The Asymmetric Digital Subscriber Line (ADSL) is a popular technological application that has become prominent recently. It utilizes the structure originally designed for view-on-demand (VOD) services. However, as the view-on-demand service was not developed as expected, and the technology of Asymmetric Digital Subscriber Line (ADSL) has not been put into widespread applications. It was not taken seriously until the worldwide popularity of the Internet began to be noticed. In most network applications, users spend lots of time fetching information from a distant server; the most obvious example of this being the World Wide Web (WWW). Users generally select an Internet Protocol (IP) address in their web browser and send out the request to a website server for downloading huge amounts of information. This is the same for the application of File Transfer Protocol (FTP) in that the amount of downloaded information is usually greater than the uploaded information. Such an asymmetric feature of data transfer is suitable for the transfer characteristics of the Asymmetric Digital Subscriber Line (ADSL). When a subscriber requests ADSL service, the local telephone and telegraph office will usually send a technician to the subscriber's end for installing an ADSL Modem. At the same time, the indoor telephone lines will be rewired and a signal splitter will be installed in the signal-carrying wire bypassing the original telephone line. The major function of the signal splitter is to filter out the noises generated by telephone communication to prevent the ADSL Modem from sharing the same signal-carrying route with the telephone line.

Under many circumstances, it is necessary for users to subscribe to two or more telephone numbers or set multiple extensions to share a single telephone number. The multiple extension lines are split from the main telephone line connected from the telephone exchange to the client end via the use of a wire shunt in order to access the service of telephone communication in various locations inside a building.

Nevertheless, in some old and outdated buildings there is only one standard telephone line socket prepared for every independent room and only one telephone set can be installed. If more extensions are needed, one has to re-setup the indoor wires. These extra re-wired cords have to be left uncovered unless the building is to be renovated. In view of esthetics and convenience, as shown in FIG. 1, the entire setup for the telephone wires will be taken into account in the design and configuration for a modem building. There will be multiple output ports extending from a distribution exchange in various locations for multiple-celled offices or residences. The telephone wires are built into the structure of a building so a user can choose an output port at a suitable location as the standard telephone socket to install a telephone set.

When a subscriber requests ADSL service, the local telephone and telegraph office provides the subscriber with a signal splitter and sets it up in an extension line connected to a telephone set for filtering out the noises generated by telephone communication to minimize the disturbance of the ADSL service.

For users with multiple output ports, however, the provision of only one signal splitter is obviously insufficient, since the telephone set connected to an output port with no signal splitter connected thereto will still cause noises that disturb other output ports carrying the ADSL signals.

For resolving the aforesaid problem, a subscriber can ask the local telephone and telegraph office to install signal splitters on all output ports, which inevitably incurs extra service fees.

Apart from that, as shown in FIG. 2, the signal splitter provided by the local telephone and telegraph office is quite large in size. Moreover, the signal splitter is installed to a standard socket via a wire so that an extra wire must be prepared before installation, and after installation there is still the inconvenience of putting wires together and finding a place for the signal splitter.

### SUMMARY OF THE INVENTION

The main object of the invention is to provide a smaller sized signal splitter for use on a client end that is more convenient for operation. Another object of the invention is to eliminate the problem of causing a telephone set's failure during use because the same telephone line carries both voice and DSL signals.

The signal splitter of the invention comprises:

an input plug for the joint with a standard socket installed in a voice-carrying wire at the client end;

at least one output socket connected to the input plug via a connection line and comprising a socket to connect to a telephone line for outputting the received signals from the input plug; and

a signal filter installed in said connection line for filtering out the noises caused from the operation of telephone communication to prevent disturbance to the ADSL signals.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a block diagram for a client end with a telephone with multiple output ports.

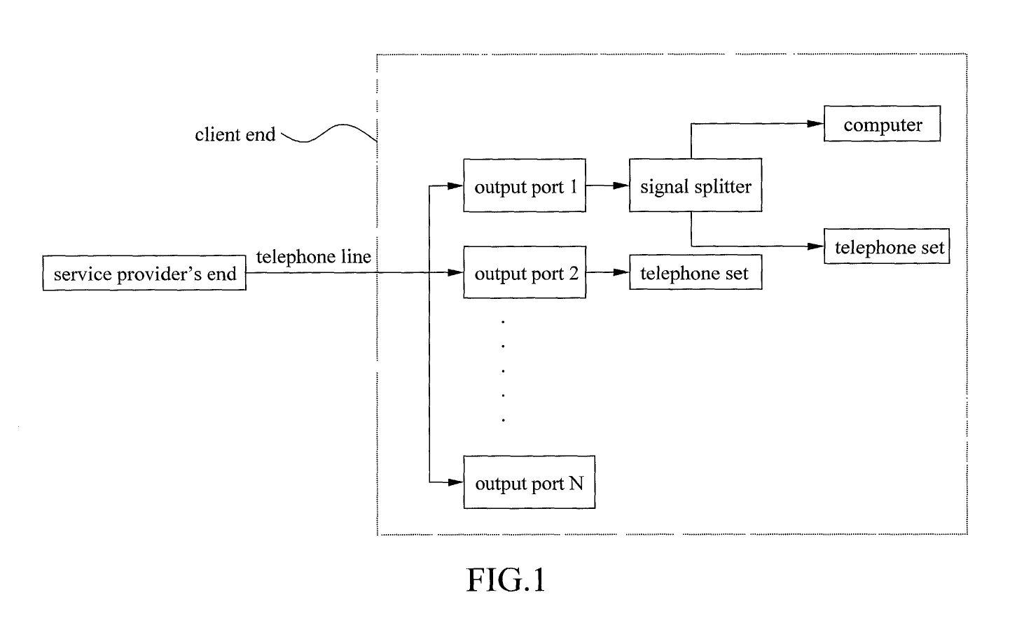

FIG. 2 is a drawing of the exterior of a general signal splitter.

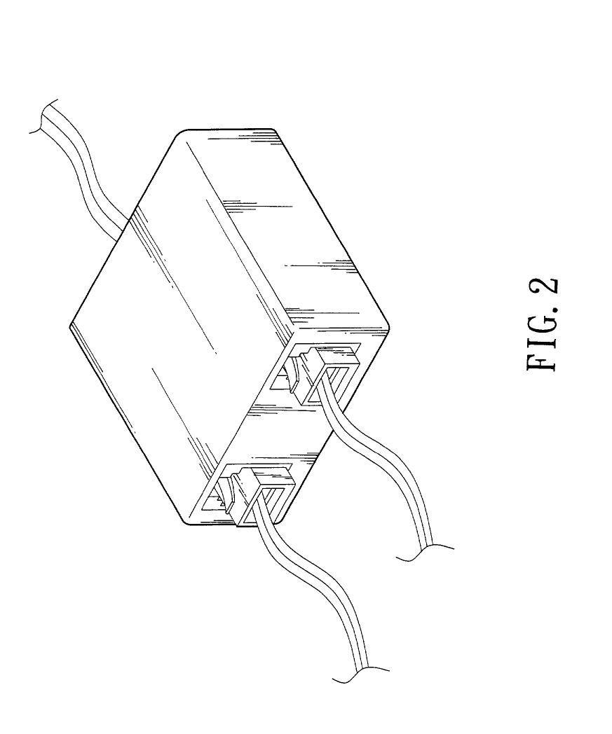

FIG. 3 is a drawing of the exterior of the first embodiment of the invention.

FIG. 4 is an exploded drawing of the first embodiment of the invention.

FIG. 5 is a drawing illustrating the usage of the first embodiment of the invention.

FIG. 6 is an exploded drawing of the second embodiment of the invention.

### DETAILED DESCRIPTION OF THE INVENTION

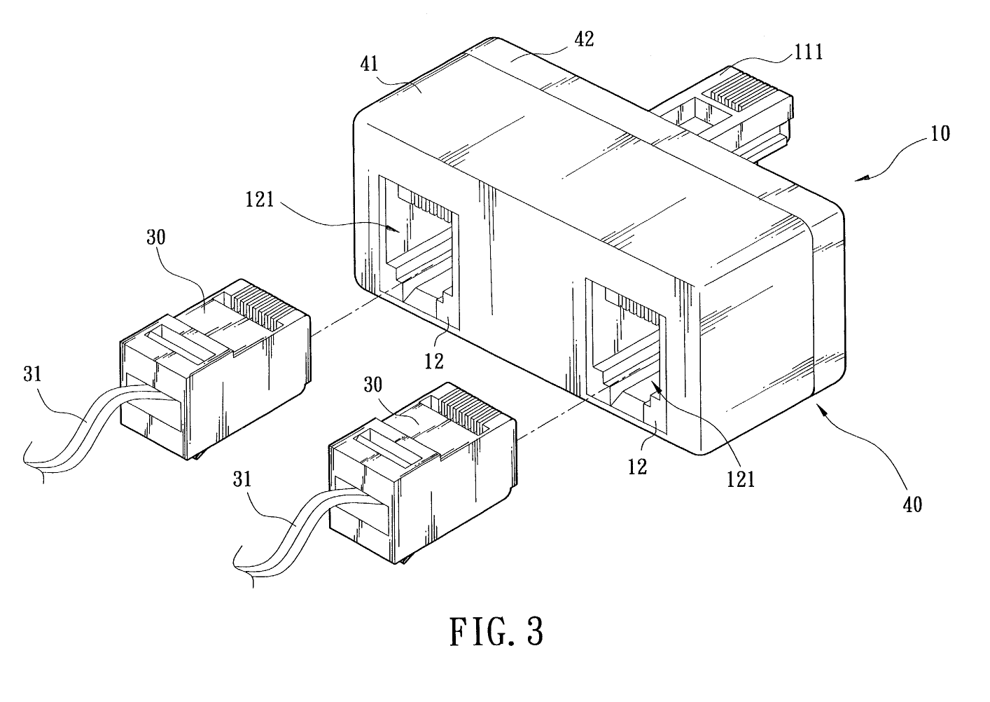

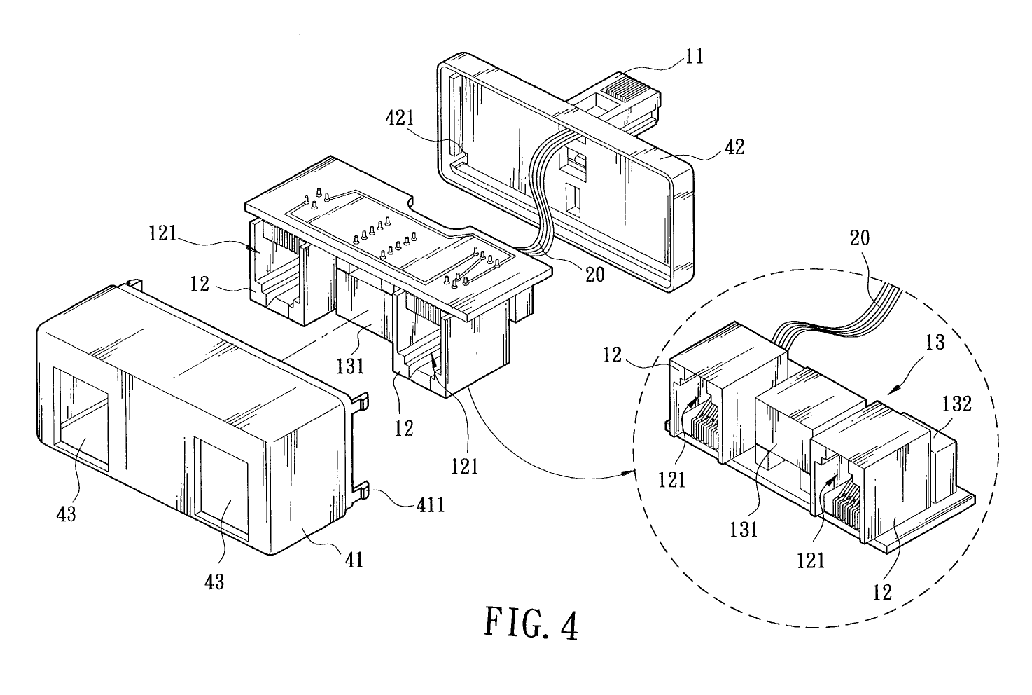

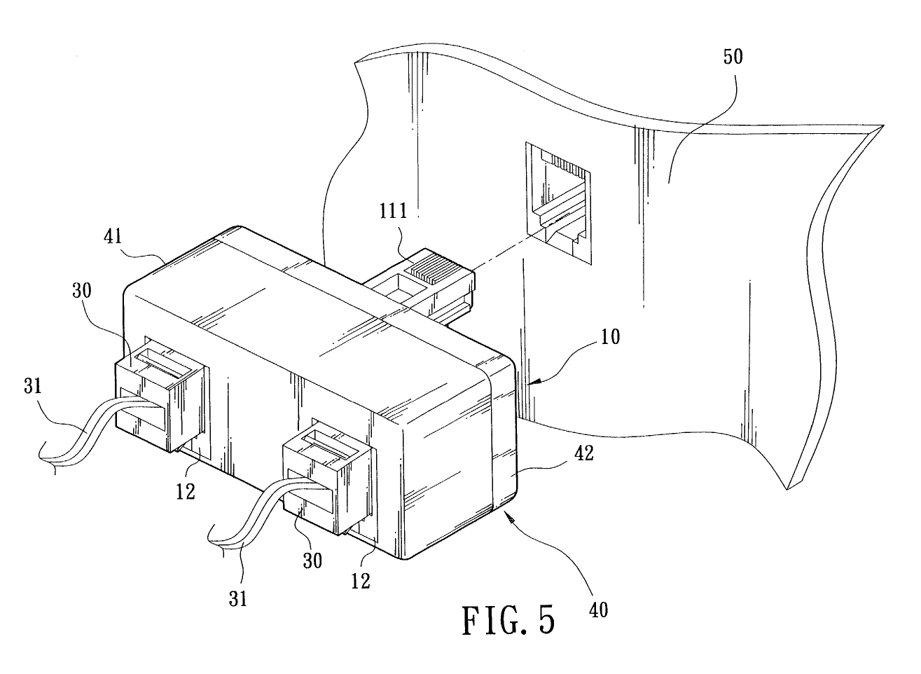

The invention is a DSL signal splitter. FIGS. 3 and 4 illustrate the preferred embodiments of the invention. The signal splitter 10 comprises an input port for connecting to a telephone line and an output port for connecting to the telephone set via a wire 31. The input port further comprises an input plug 11 capable of coupling and jointing a standard socket 50 of a client end, as shown in FIG. 5. The output port comprises at least one socket 12, which is connected to the aforesaid input plug via a connection wire 20, with a slot 121 for connection to the plug 30 of a telephone cord 31. For filtering out noises, a signal filter 13 is installed in the signal splitter 10. The signal filter 13 consists of a transformer 131 and a capacitor 132, which are connected to the connection wire 20 of the input plug 11 and the socket 12, respectively.

In the present embodiment, the aforesaid input plug 11, socket 12, and signal filter 13 are integrated into a housing 40. As shown in the figures, the housing 40 consists of a bowl-shaped seat 41 and a cover 42, which comprises a wedge member 411s and a wedge-stopping slot 421s, respectively. The seat 41 and the cover 42 can be jointed together by clipping the wedge member 41s and the wedge-stopping slot 421s. In the preferred embodiment, the input plug 11 protrudes out from the housing 40. There is an opening 43 opposite the slot 121 for the wire 31 to go through and plug into the slot 121.

Through the construction of the aforesaid components, as shown in FIG. 5, users can put the plug 11 of the signal splitter 10 as disclosed in the invention into the standard socket 50, and connect both the telephone set and the ADSL Modem to the socket 12 via the wire 31s.

The signal filter 13 set up in the connection wire 20 between the socket 12 and the input plug 11 filters out noises caused by telephone communication, since the telephone set is connected to the socket 12 comprising said signal filter 13.

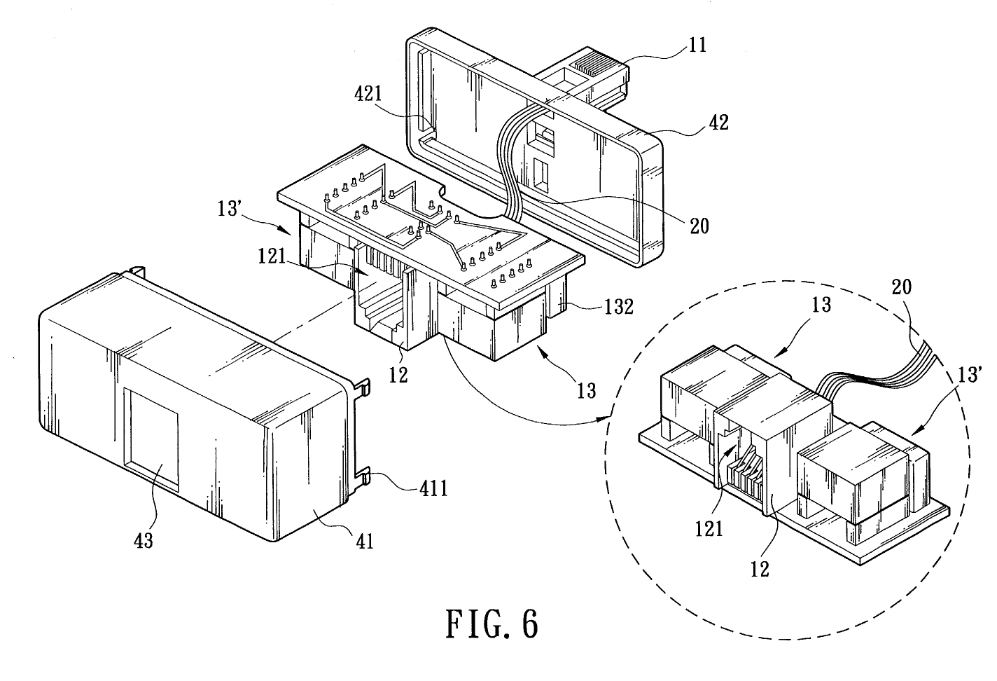

In another preferred embodiment of the invention, as shown in FIG. 6, the signal splitter 10 comprises a socket consisting of two sets of signal filters 13 and 13′. The object of such a design is mainly to connect two telephone wires with two different telephone numbers. Therefore, each of the signal filters 13 and 13′ can filter out the noises from a telephone set connected thereto, to prevent other Modems connected to the standard socket 50 from disturbance.

Based on the technology as disclosed in the aforesaid, the invention has the following advantages:

(1) The signal splitter of the invention is connected to a standard socket of a client end through the input plug, which obviates the need for connection with an extra wire and thus avoids the inconvenience of putting wires together and finding a place for the signal splitter.

(2) The signal splitter of the invention is easy and convenient to use because it is a plug-and-play device.

(3) The signal splitter of the invention is small in size, occupies less space, and is easy to store.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An adapter socket seat of DSL for use in a telephone line of client end combining both voice signals and DSL signals, comprising:
an input plug for the joint with a standard socket installed in a voice-carrying wire at the client end;
at least one output socket connected said input plug via a connection line and comprising a socket to connect to a telephone line for outputting the received signals from said input plug; and
a signal filter installed in said connection line for filtering out the noises caused from the operation of telephone communication to prevent the ADSL signals from disturbances.

2. The adapter socket seat of DSL as disclosed in claim 1, wherein said signal filter further comprises a transformer and a capacitor.

3. The adapter socket seat of DSL as disclosed in claim 1, wherein said adapter socket seat comprises at least two said output sockets and some said connection lines between said output sockets and said input plug don't comprise said signal filters.

4. The adapter socket seat of DSL as disclosed in claim 1, wherein said input plug, said output socket, and said signal filter are incorporated into a housing.

5. The adapter socket seat of DSL as disclosed in claim 4, wherein said housing comprises a bowl-shaped seat and a cover jointed to said bowl-shaped seat.

6. The adapter socket seat of DSL as disclosed in claim 5, wherein said seat and said cover comprise wedge members and wedge-stopping slot for clipping to connect said seat and said cover together.

7. The adapter socket seat of DSL as disclosed in claim 4, wherein said housing further comprises an opening opposite to said output socket for the telephone wire to go through said housing and then connect to said output socket.
